(19) United States
(12) Patent Application Publication
(10) Pub. No.: US 2017/0111715 A1
(43) Pub. Date: Apr. 20, 2017

(54) OPTICALLY CONNECTABLE CONTROLLER USING PASSIVE OPTICAL DEVICES

(71) Applicant: HYUNDAI INFRACORE, Inc., Seoul (KR)

(72) Inventor: Jong Seog YANG, Seoul (KR)

(21) Appl. No.: 14/884,844

(22) Filed: Oct. 16, 2015

(51) Int. Cl. H04Q 11/00; H04L 5/14

(52) U.S. Cl. CPC H04Q 11/0003; H04L 5/14; H04Q 11/0067; H04Q 2011/0015; H04Q 2011/0033; H04Q 2011/0049

(57) ABSTRACT

An optical connectable controller is disclosed. The optical connectable controller includes an optical splitter, an optical combiner, an optical reception unit, an optical transmission unit, and a communication control unit. The optical splitter splits an optically received downstream optical signal into a branch optical signal and a pass-through optical signal. The optical combiner optically combines an outgoing optical signal and an upstream optical signal into a combined upstream optical signal. The optical reception unit receives the branch optical signal, and converts the branch optical signal into an incoming electric signal to be transferred to the communication control unit. The optical transmission unit receives the outgoing electric signal, and converts the outgoing electric signal into the outgoing optical signal. The communication control unit extracts an address, outputs control commands or data or discards the incoming electric signal, generates the outgoing electric signal, and outputs the outgoing electric is signal.

### CROSS-REFERENCE TO RELATED APPLICATIONS

This application claims the benefit under 35 USC 119(a) of Korean Patent Application No. 10-2014-0045849 filed on Apr. 17, 2014 in the Korean Intellectual Property Office, the entire disclosure of which is incorporated herein by reference for all purposes.

### BACKGROUND

Field

The present invention relates to an optical connectable controller.

Description of Related Art

The conventional EIA-485/422 telecommunication standards have been widely used as telecommunication standards for 1:N or N:N digital communication. The EIA-485/422 standards use differential signals, and thus they are robust to noise and can support high-speed data communication even over a relatively long distance, for example, about 1.5 Km. The EIA-485 standard uses a half-duplex method using two wire transmission lines, and enables only transmission or reception at a moment. In contrast, the EIA-422 standard uses a full-duplex method using four wire transmission lines, and enables both transmission and reception at any moment. However, in both of the EIA-485/422 standards, only one device can exclusively occupy a communication line at one time.

Although max 32 devices can be connected according to recommendation, the number of connected devices can exceed 32 by simply connecting more than 32 devices or by using one device as a gateway to which 32 subordinate devices are additionally connected, and thus a larger number of devices are usually connected and used in real fields.

Automation networks based on the EIA-485/422 standards or Ethernet standards have been used in various fields, such as buildings, factories, homes, large scale complexes, venues, etc. While networks based on the EIA-485/422 standards were originally intended to be used to control dozens of devices, they are currently used such that even hundreds of devices are connected with by electric wires having a length of a few kilometers at maximum. In such cases, transmitting data to or from peripheral devices would be very slow as a matter of fact, and the probability of data loss becomes very significant. In particular, for data loss, a device that sent data cannot become aware of whether data get lost, and a data receiving side cannot become aware of the fact itself that data is sent. Accordingly, re-transmission is impossible and the reliability of a system may be significantly degraded.

In particular, in systems in which real-time propriety and reliability are very important, such as fire alarm systems or burglar alarm systems, slow speed due to the configuration of a large scale network and poor reliability attributable to loss of data are critical problems.

Meanwhile, a passive Planar Lightwave Circuit (PLC) device and a passive Fused Biconic Taper (FBT) device are optical devices, such as an optical splitter or an optical combiner, using, for example, a Y-shaped branched optical waveguide, or a directional coupling waveguide based on an optical transition phenomenon. A PLC device is fabricated using a method of forming waveguide and clad on substrate using lithography method, and an FBT device is fabricated using a method of forming dual biconic shape by tapering and fusing optical fiber while applying heat thereto.

Although passive optical devices have simple structures and must bear some coupling loss compared to active optical devices which convert electric signals into optical signals, they can be manufactured at low cost and can split a signal or combine signals without additionally consuming energy.

### SUMMARY

At least one embodiment of the present invention is directed to the provision of an optical connectable controller using passive optical devices.

At least one embodiment of the present invention is directed to the provision of an optical connectable controller using passive optical devices, which has a simple structure and is inexpensive.

In accordance with an aspect of the present invention, there is provided an optical connectable controller, including an optical splitter configured to split an optically received downstream optical signal into a branch optical signal and a pass-through optical signal, an optical combiner configured to optically combine an outgoing optical signal, generated by the optical connectable controller, and an upstream optical signal, optically received from another optical connectable controller, into a combined upstream optical signal, an optical reception unit configured to receive the branch optical signal, to convert the branch optical signal into an incoming electric signal, and to transfer the incoming electric signal to a communication control unit, an optical transmission unit configured to receive an outgoing electric signal from the communication control unit, and to convert the outgoing electric signal into the outgoing optical signal, and the communication control unit configured to extract an address included in the incoming electric signal, to output a control command or data extracted from the incoming electric signal depending on the address via a local communication interface, to discard the incoming electric signal depending on the address, to generate the outgoing electric signal based on data being input via the local communication interface, and to output the generated outgoing electric signal to the optical transmission unit.

The optical splitter may include a downstream optical signal waveguide configured to receive the downstream optical signal, a splitting unit configured to optically split the downstream optical signal guided via the downstream optical signal waveguide to the splitting unit, into the branch optical signal and the pass-through optical signal, a branch optical signal waveguide configured to output the branch optical signal to the optical reception unit, and a pass-through optical signal waveguide configured to externally output the pass-through optical signal from the splitting unit.

The optical combiner may include an upstream optical signal waveguide configured to receive an upstream optical signal transferred from another optical connectable controller, an outgoing optical signal waveguide configured to receive the outgoing optical signal from the optical transmission unit, a combination unit configured to optically combine the upstream optical signal guided via the upstream optical signal waveguide to the combination unit, and the outgoing optical signal guided via the outgoing optical signal waveguide, into a combined upstream optical signal, and a combined optical signal waveguide configured to externally output the combined upstream optical signal.

The optical splitter or the optical combiner may be implemented as a Planar Lightwave Circuit (PLC) based passive optical element or a Fused Biconic Taper (FBT) based passive optical element.

The optical splitter or the optical combiner may be implemented as a Y-shaped waveguide or a directional coupling combiner.

The downstream optical signal may be generated by at least one master device, and be applied to the optical splitter of the optical connectable controller directly or via an optical splitter of at least one additional optical connectable controller, and the combined upstream optical signal may be transmitted to the at least one master device directly or via an optical combiner of the at least one additional optical connectable controller.

In accordance with an aspect of the present invention, there is provided a multi-drop master-slave system, including a master server configured to operate as a master of a multi-drop network, and slave optical connectable controllers connected to the master server in a multi-drop configuration via a downstream optical cable and an upstream optical cable, wherein each of the slave optical connectable controllers includes an optical splitter configured to split a downstream optical signal, optically received via the downstream optical cable, into a branch optical signal and a pass-through optical signal, an optical combiner configured to optically combine an outgoing optical signal, generated by the slave optical connectable controller, and an upstream optical signal, optically received from another slave optical connectable controller via the upstream optical cable, into a combined upstream optical signal, an optical reception unit configured to receive the branch optical signal, to convert the branch optical signal into an incoming electric signal, and to transfer the incoming electric signal to a communication control unit, an optical transmission unit configured to receive an outgoing electric signal from the communication control unit, and to convert the outgoing electric signal into the outgoing optical signal, and the communication control unit configured to extract an address included in the incoming electric signal, to output a control command or data extracted from the incoming electric signal depending on the address via a local communication interface, to discard the incoming electric signal depending on the address, to generate the outgoing electric signal based on data being input via the local communication interface, and to output the generated outgoing electric signal to the optical transmission unit.

The master server and the slave optical connectable controllers may operate in a time synchronized state in accordance with a time-division method, in which any one of the slave optical connectable controllers outputs an upstream optical signal designated to the master server via the upstream optical cable during each time span in accordance with a predetermined time-division algorithm.

The master server and the slave optical connectable controllers may operate in accordance with a polling method, in which the master server calls a specific slave optical connectable controller in accordance with a predetermined polling algorithm and the called specific slave optical connectable controller outputs an upstream optical signal to the master server via the upstream optical cable.

The master server and the slave optical connectable controllers may operate in accordance with an interrupt method, in which, when a specific slave optical connectable controller in which an event has occurred generates an interrupt and optically outputs the generated interrupt to the master server, the master server is operative to receive an upstream optical signal corresponding to the interrupt and to send a downstream optical signal, including data transmission permission, to the specific slave optical connectable controller that has generated the interrupt, and the specific slave optical connectable controller that has received the data transmission permission is operative to output an upstream optical signal to the master server via the upstream optical cable.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram illustrating an optical connectable controller according to an embodiment of the present invention, and

FIG. 2 is a diagram illustrating a multi-drop master-slave system that is composed by connecting a plurality of optical connectable controllers according to embodiments of the present invention.

### DETAILED DESCRIPTION

With regard to embodiments of the present invention disclosed herein, specific structural and functional descriptions are given merely for the purpose of illustrating the embodiments of the present invention. Embodiments of the present invention may be practiced in various forms, and the present invention should not be construed as being limited to the embodiments disclosed herein.

Embodiments of the present invention will be described in detail below with reference to the accompanying drawings. The same reference numerals will be used to denote the same components throughout the accompanying drawings, and redundant descriptions of the same components will be omitted.

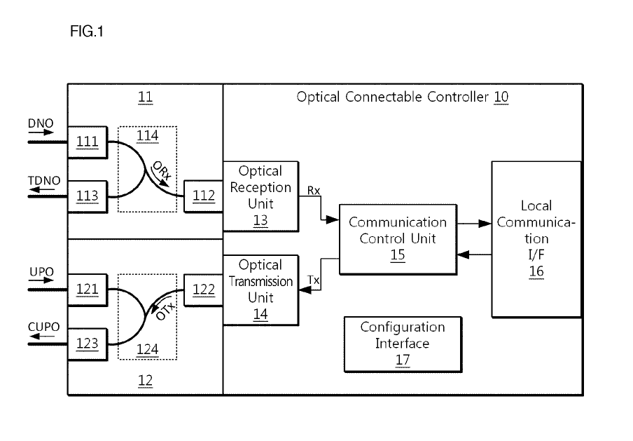

FIG. 1 is a conceptual diagram illustrating an optical connectable controller 10 according to an embodiment of the present invention.

Referring to FIG. 1, the optical connectable controller 10 may include an optical splitter 11, an optical combiner 12, an optical reception unit 13, an optical transmission unit 14, a communication control unit 15, a local communication interface 16, and a configuration interface 17.

The optical connectable controller 10 may optically receive a downstream optical signal from at least one master device directly or via at least one additional optical connectable controller, or may optically transmit an outgoing optical signal, internally generated, or an upstream optical signal, optically received via another optical connectable controller, to at least one master device directly or via at least one additional optical connectable controller.

Furthermore, the optical connectable controller 10 may relay an optical signal between at least one master device and other optical connectable controllers functioning as a plurality of slaves.

More specifically, the optical splitter 11 and the optical combiner 12 are Planar Lightwave Circuit (PLC)-based or Fused Biconic Taper (FBT)-based passive optical devices.

The optical splitter 11 splits a downstream optical signal DNO, optically received from at least one master device (not shown) directly or via at least one additional optical connectable controller (not shown), into a branch optical signal ORx and a pass-through optical signal TDNO.

More specifically, the optical splitter 11 receives the downstream optical signal DNO from a downstream optical signal waveguide 111, splits the downstream optical signal DNO into the branch optical signal ORx and the pass-through optical signal TDNO at a splitting unit 114, outputs the branch optical signal ORx at a branch optical signal waveguide 112, and outputs a pass-through optical signal TDNO at a pass-through optical signal waveguide 113.

The pass-through optical signal TDNO may function as a downstream optical signal for another optical connectable controller that is subsequently connected.

The optical splitter 11 may include the splitting unit 114 configured such that the core widths of two divided waveguides are different, i.e., configured to be asymmetric, and may split the downstream optical signal DNO at an unbalanced split ratio in which the ratio of the intensity of the branch optical signal ORx to the intensity of the pass-through optical signal TDNO is, for example, 1:N. In this case, the split ratio may be determined to be a split ratio that is sufficient for other optical connectable controllers 10, which will receive the pass-through optical signal TDNO, to receive an optical signal having sufficient intensity.

The splitting unit 114 may be implemented as a Y-shaped waveguide or a directional coupling combiner.

The branch optical signal ORx is input to the optical reception unit 13 optically connected, preferably directly connected, to the branch optical signal waveguide 112 of the optical splitter 11, and the pass-through optical signal TDNO is optically output from the pass-through optical signal waveguide 113 of the optical splitter 11.

The optical reception unit 13 receives the branch optical signal ORx from the branch optical signal waveguide 112 optically connected, preferably directly connected, to the optical reception unit 13, converts the branch optical signal ORx into an incoming electric signal Rx, and transfers the incoming electric signal Rx to the communication control unit 15.

Meanwhile, the optical combiner 12 optically combines an outgoing optical signal OTx, generated by the optical connectable controller 10 itself, and an upstream optical signal UPO, optically received via another optical connectable controller (not shown), into a combined upstream optical signal CUPO, and may transmit the generated combined upstream optical signal CUPO to at least one master device (not shown) directly or via at least one additional optical connectable controller (not shown).

More specifically, the optical combiner 12 receives the upstream optical signal UPO, transferred via another optical connectable controller, at an upstream optical signal waveguide 121, receives the outgoing optical signal OTx at an outgoing optical signal waveguide 122, optically combines the upstream optical signal UPO and the outgoing optical signal OTx into the combined upstream optical signal CUPO at, for example, the Y-shaped combination unit 124, and outputs the combined upstream optical signal CUPO at a combined optical signal waveguide 123.

The optical combiner 12 may include a combination unit 124 in which the core widths of two waveguides that are combined are the same, i.e., which is symmetrical.

The combination unit 124 may be implemented as a Y-shaped waveguide or a directional coupling combiner.

In an embodiment, optical connectable controllers 10 that operate as a plurality of slaves may be controlled to communicate with a master in a non-contention manner, or exclusively, during a given period of time after being called by the master using a polling method, and thus possibility that the upstream optical signal UPO and the outgoing optical signal OTx are simultaneously applied and optically mixed at the optical combiner 12 may be excluded.

In an embodiment, optical connectable controllers 10 that operate as a plurality of slaves may be controlled to notify a master of the occurrence of a predetermined event using an interrupt method, when the event occurs, and to communicate with the master in a non-contention manner, or exclusively, for a period of time that is guaranteed by the master.

In this case, substantially, the term “combined upstream optical signal CUPO” is a term that is used merely to be distinguished from the upstream optical signal UPO applied to the upstream optical signal waveguide 121, rather than to refer to an optical signal in which the optical wave of the upstream optical signal UPO and the optical wave of the outgoing optical signal OTx are mixed, and may be viewed as a term that refers to any one of the upstream optical signal UPO and the outgoing optical signal OTx that are not overlapped with each other.

The optical splitter 11 and the optical combiner 12 are passive optical devices, and thus may transfer a downstream optical signal or an upstream optical signal to another optical connectable controller or the master even though the corresponding optical connectable controller 10 stops operation due to defective power or turning to power saving mode.

Furthermore, the optical connectable controller 10 using the optical splitter 11 and the optical combiner 12 according to the present invention rarely has time delay compared to a conventional method of transferring an optical signal upwardly or downwardly in a way of first converting the optical signal to an electric signal and then again converting the electric signal to another optical signal.

The optical transmission unit 14 may receive an outgoing electric signal Tx from the communication control unit 15, may convert the outgoing electric signal Tx into an outgoing optical signal OTx, and may apply the outgoing optical signal OTx to the outgoing optical signal waveguide 122 of the optical combiner 12 optically connected, preferably directly connected, to the optical transmission unit 14.

The communication control unit 15 extracts an address, a control command and data included in the incoming electric signal Rx input via the optical splitter 11 and the optical reception unit 13, and, if it is determined that the extracted address is an address corresponding to the corresponding optical connectable controller 10, outputs the control command or data, extracted from the incoming electric signal, via the local communication interface 16. In contrast, if the extracted address is not related to the corresponding optical connectable controller 10, the communication control unit 15 disregards and discards the received control command and the data.

The communication control unit 15 may generate an outgoing electric signal Tx based on generation data transferred via the local communication interface 16, and may output the outgoing electric signal Tx to the optical transmission unit 14 in accordance with the transmission permission-related control command among the control command extracted from the incoming electric signal.

In an embodiment, the communication control unit 15 may be designed to support a full-duplex/half-duplex communication method or a synchronous/asynchronous communication method as required in order to have, for example, compatibility with a conventional multi-drop EIA-485/422 network.

The local communication interface 16 may be an internal bus used for internal communication, or a communication interface adapted to support wired communication specifications, such as RS-232C, EIA-485, EIA-422, Ethernet or the like, or wireless communication specifications, such as Bluetooth, WiFi Direct, ZigBee, or the like, that enable communication with the outside.

The configuration interface 17 may be implemented using a dual in-line package (DIP) switch or the like. A user may set an address or the like, to which the communication control unit 15 will refer, via the configuration interface 17.

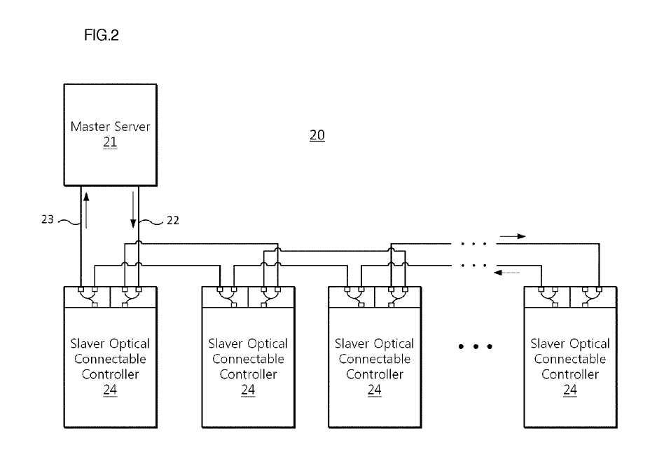

FIG. 2 is a diagram illustrating a multi-drop master-slave system that is composed by connecting a plurality of optical connectable controllers according to embodiments of the present invention.

The multi-drop master-slave system 20 may include a master server 21, a downstream optical cable 22, an upstream optical cable 23, and slave optical connectable controllers 24 connected in a multi-drop configuration.

The slave optical connectable controllers 24 may be connected using a full-duplex/half-duplex type multi-drop method.

A downstream optical signal output to the slave optical connectable controller 24 having a specific address by the master server 21 is applied to the downstream optical signal waveguides of the optical splitters of the slave optical connectable controllers 24 along the downstream optical cable 22.

Each of the slave optical connectable controllers 24 extracts an address from an incoming electric signal obtained by electrically converting a branch optical signal, split off from a downstream optical signal, to the incoming electric signal, and processes a control command or data included in the incoming electric signal if the extracted address is an address corresponding to itself, and discard the incoming electric signal if not.

Furthermore, an upstream optical signal output by each of the slave optical connectable controllers 24 is applied to the upstream optical signal waveguides of the optical combiners of the slave optical connectable controllers 24 along a path up to the master server 21 via the upstream optical cable 23.

In this case, the upstream optical signal is output to the upstream optical cable 23 via the combined optical signal waveguides of the optical combiners immediately right after the upstream optical signal is applied to the upstream optical signal waveguides of the optical combiners of the slave optical connectable controllers 24. Accordingly, there is no processing operation that is particularly performed on the upstream optical signal by the slave optical connectable controllers 24.

Meanwhile, since the slave optical connectable controllers 24 cannot become aware of the presence of an upstream optical signal that passes therethrough, the slave optical connectable controllers 24 may not adopt a contention method but may use a non-contention method, such as a time-division communication method, a polling method or an interrupt method, as media access control (MAC) methods.

In an embodiment, to prevent cross-talking between an upstream optical signal and an outgoing optical signal, using a time-division communication method, any one slave optical connectable controller 24 may output data to the master server 21 as an upstream optical signal in each time span in accordance with a predetermined time-division algorithm, while the master server 21 and the slave optical connectable controllers 24 are all time-synchronized.

In an embodiment, to prevent cross-talking between an upstream optical signal and an outgoing optical signal, using a polling method, the master server 21 may call a specific slave optical connectable controller 24 in accordance with a predetermined polling algorithm, and only the called specific slave optical connectable controller 24 may output data as an upstream optical signal.

In another embodiment, in accordance with an interrupt method, a specific slave optical connectable controller 24 in which an event has occurred may generate an interrupt, and may optically output the generated interrupt.

In this case, the master server 21 may receive an upstream optical signal corresponding to the interrupt, and may send a downstream optical signal, including data transmission permission, to the slave optical connectable controller 24 that has generated the interrupt. Only the specific slave optical connectable controller 24 that has received the data transmission permission may be allowed to output data as an upstream optical signal.

The master server 21 may perform control so that other slave optical connectable controllers do not output an outgoing optical signal while the specific slave optical connectable controller 24 is outputting an outgoing optical signal and an upstream optical signal is being generated in the upstream optical cable 23. For example, since a downstream optical signal is transferred to all the slave optical connectable controllers 24 in common, devices, other than the specific slave optical connectable controller 24 that has received the data transmission permission, may stop the output of an optical signal.

If the master server 21 does not send an ACK signal due to the collision of the received upstream optical signal, the slave optical connectable controller 24 must resend an optical signal when an ACK signal has not been received within a predetermined period of time. In this case, since the transmission speed of optical communication is very fast, the resending does not greatly affect overall transmission throughput.

In accordance with at least one embodiment of the present invention, there is provided an optical connectable controller using passive optical devices, which implements an optical communication relay function using only an optical splitter and an optical combiner, so as to inexpensively implement an optical connectable controller with simple structure.

In accordance with at least one embodiment of the present invention, there is provided an optical connectable controller using passive optical devices, which can use an optical input element or an optical output element instead of an optical in/out element, so as to inexpensively implement an optical connectable controller.

The above embodiments and the accompanying drawings are intended merely to clearly illustrate part of the technical spirit of the present invention, and it will be apparent to those skilled in the art that modifications and specific embodiments that those skilled in the art can easily derive from the present specification and the accompanying drawings are all included in the range of the rights of the present invention.

1. An optical connectable controller, comprising:
an optical splitter configured to optically receive a downstream optical signal and to split the downstream optical signal into a branch optical signal and a pass-through optical signal, the pass-through optical signal being transferred to another optical connectable controller as the downstream optical signal;
an optical combiner configured to optically combine an outgoing optical signal, generated by the optical connectable controller, and an upstream optical signal, optically received from said another optical connectable controller, into a combined upstream optical signal;
an optical reception unit configured to receive the branch optical signal, to convert the branch optical signal into an incoming electric signal, and to transfer the incoming electric signal to a communication control unit;
an optical transmission unit configured to receive an outgoing electric signal from the communication control unit, and to convert the outgoing electric signal into the outgoing optical signal; and
the communication control unit configured to extract an address included in the incoming electric signal, to output a control command or data extracted from the incoming electric signal depending on the address via a local communication interface, to discard the incoming electric signal depending on the address, to generate the outgoing electric signal based on data being input via the local communication interface, and to output the generated outgoing electric signal to the optical transmission unit.

2. The optical connectable controller of claim 1, wherein the optical splitter comprises:
a downstream optical signal waveguide configured to receive the downstream optical signal;
a splitting unit configured to optically split the downstream optical signal guided via the downstream optical signal waveguide to the splitting unit, into the branch optical signal and the pass-through optical signal;
a branch optical signal waveguide configured to output the branch optical signal to the optical reception unit; and
a pass-through optical signal waveguide configured to externally output the pass-through optical signal from the splitting unit.

3. The optical connectable controller of claim 1, wherein the optical combiner comprises:
an upstream optical signal waveguide configured to receive an upstream optical signal transferred from another optical connectable controller;
an outgoing optical signal waveguide configured to receive the outgoing optical signal from the optical transmission unit;
a combination unit configured to optically combine the upstream optical signal guided via the upstream optical signal waveguide to the combination unit, and the outgoing optical signal guided via the outgoing optical signal waveguide, into a combined upstream optical signal; and
a combined optical signal waveguide configured to externally output the combined upstream optical signal.

4. The optical connectable controller of claim 1, wherein the optical splitter or the optical combiner is implemented as a Planar Lightwave Circuit (PLC)-based or Fused Biconic Taper (FBT)-based passive optical element.

5. The optical connectable controller of claim 4, wherein the optical splitter or the optical combiner is implemented as a Y-shaped waveguide or a directional coupling combiner.

6. The optical connectable controller of claim 1, wherein:
the downstream optical signal is generated by at least one master device, and be applied to the optical splitter of the optical connectable controller directly or via an optical splitter of at least one additional optical connectable controller; and
the combined upstream optical signal is transmitted to the at least one master device directly or via an optical combiner of the at least one additional optical connectable controller.

7. A multi-drop master-slave system, comprising:
a master server configured to operate as a master of a multi-drop network; and
slave optical connectable controllers connected to the master server in a multi-drop configuration via a downstream optical cable and an upstream optical cable;
wherein each of the slave optical connectable controllers includes:
an optical splitter configured to receive optically a downstream optical signal via the downstream optical cable, and to split the downstream optical signal into a branch optical signal and a pass-through optical signal, the pass-through optical signal being transferred to another optical connectable controller as the downstream optical signal;
an optical combiner configured to optically combine an outgoing optical signal, generated by the slave optical connectable controller, and an upstream optical signal, optically received from said another slave optical connectable controller via the upstream optical cable, into a combined upstream optical signal;
an optical reception unit configured to receive the branch optical signal, to convert the branch optical signal into an incoming electric signal, and to transfer the incoming electric signal to a communication control unit;
an optical transmission unit configured to receive an outgoing electric signal from the communication control unit, and to convert the outgoing electric signal into the outgoing optical signal; and
the communication control unit configured to extract an address included in the incoming electric signal, to output a control command or data extracted from the incoming electric signal depending on the address via a local communication interface, to discard the incoming electric signal depending on the address, to generate the outgoing electric signal based on data being input via the local communication interface, and to output the generated outgoing electric signal to the optical transmission unit.

8. The multi-drop master-slave system of claim 7, wherein the master server and the slave optical connectable controllers operate in a time synchronized state in accordance with a time-division method, in which any one of the slave optical connectable controllers outputs an upstream optical signal designated to the master server via the upstream optical cable during each time span in accordance with a predetermined time-division algorithm.

9. The multi-drop master-slave system of claim 7, wherein the master server and the slave optical connectable controllers operate in accordance with a polling method, in which the master server calls a specific slave optical connectable controller in accordance with a predetermined polling algorithm and the called specific slave optical connectable controller outputs an upstream optical signal to the master server via the upstream optical cable.

10. The multi-drop master-slave system of claim 7, wherein the master server and the slave optical connectable controllers operate in accordance with an interrupt method, in which, when a specific slave optical connectable controller in which an event has occurred generates an interrupt and optically outputs the generated interrupt to the master server, the master server is operative to receive an upstream optical signal corresponding to the interrupt and to send a downstream optical signal, including data transmission permission, to the specific slave optical connectable controller that has generated the interrupt, and the specific slave optical connectable controller that has received the data transmission permission is operative to output an upstream optical signal to the master server via the upstream optical cable.
